(19) United States
(12) Patent Application Publication
(10) Pub. No.: US 2007/0289403 A1
(43) Pub. Date: Dec. 20, 2007

(54) Operating pedal for operating running of industrial vehicle and industrial vehicle having the same

(76) Inventors: Toshihiro Yoshihara, Kariya-shi (JP); Kazushi Kamiya, Kariya-shi (JP)

Correspondence Address: MORGAN & FINNEGAN, L.L.P., 3 WORLD FINANCIAL CENTER, NEW YORK, NY, 10281-2101, US

(21) Appl. No.: 11/818,803

(22) Filed: Jun. 14, 2007

(30) Foreign Application Priority Data
Jun. 15, 2006 (JP) P2006-166321

(51) Int. Cl. G05G 1/16; B62D 1/22

(52) U.S. Cl. 74/562.5; 180/323; 74/512

(57) ABSTRACT

An industrial vehicle includes an operating pedal depressed by an operator for operating running of the industrial vehicle. The operating pedal includes a first pedal portion having a first step surface which is depressed by the operator while the operator maintains his or her posture to look forward and a second pedal portion having a second step surface which is depressed by the operator while the operator maintains his or her posture to look backward. The second pedal portion is formed on a lateral side of the first pedal portion so as to be inclines with respect to such that an angle made between the first step surface and the second step surface is an obtuse angle.

### BACKGROUND OF THE INVENTION

The present invention relates to an accelerator pedal and an industrial vehicle having the same.

In loading and unloading operation by an industrial vehicle such as a forklift truck, when multiple loads are carried by the forklift truck or forks are raised, the forward view of the forklift truck operator is blocked and, therefore, visibility of the operator's forward view may become difficult to be ensured. In order to overcome such a problem, the operator often drives the forklift truck backward with loads carried on the forks to ensure visibility. During such backward driving, the operator sitting on the operator's seat turns his or her head and part of the body to look behind while driving backward. Keeping this posture, the operator manipulates a steering wheel and operates an accelerator pedal. The accelerator pedal of a forklift truck whose step surface is of a rectangle or parallelogram is widely used so that the operator can push the accelerator pedal ordinarily in a position where he or she faces forward.

Meanwhile, in driving a forklift truck having a fixed seat, the operator looking behind during backward driving needs to twist the upper part of his or her body and keeping such a posture causes the operator to increase his or her fatigue. Japanese Unexamined Patent Application Publications Nos. 2001-248461, 2005-335854 and 2000-318498 disclose a seat swiveling device which can change the direction of a seat. A forklift truck having any one of the seat swiveling devices disclosed in the Japanese Unexamined Patent Application Publications can decrease the extent of body twisting of the operator thereby to reduce the fatigue.

On the other hand, when the operator twists the upper part of his or her body rightward to look backward in rearward driving of a forklift truck having a fixed seat, the operator's right knee is moves rightward. Meanwhile, when a forklift truck having the seat swiveling device is driven backward, the operator swivels or turns the seat clockwise as seen from the top for a predetermined angle to look backward, and twists the upper part of his or her body toward the right for about the same angle. Then, the operator twists the body further to the right to look backward. The use of the swiveling seat serves to decrease the extent of body twisting of the operator as compared with a case of using a fixed seat. When the operator twist the upper part of the body to look backward, however, the operator's right knee is turned toward the right as well as in the case of the fixed seat. When driving the forklift truck backward, the operator's right foot tends to be turned rightward about his or her heel and the heel to be moves rightward away from the accelerator pedal in both cases of using a fixed seat and swivel seat, with the result that the accelerator pedal are difficult to be operated properly in driving the vehicle backward. Therefore, there has been a need for improving the pedal operability.

The Japanese Unexamined Patent Application Publication No. 2001-248461 discloses an industrial vehicle having a main accelerator pedal which is interlocked with an auxiliary accelerator pedal in conjunction with the operation of a seat swiveling device. However, the industrial vehicle of the above Publication requires the additional auxiliary accelerator pedal and the interlock mechanism for the additional accelerator pedal, so that the number of parts for the vehicle is increased and additional assembling needs be performed, with the result that the cost of the industrial vehicle is increased. Meanwhile, the Japanese Unexamined Patent Application Publications Nos. 2005-335854 and 2000-318498 disclose a seat assembly for an industrial vehicle such as a forklift truck, having a seat swiveling shaft which is provided at a position adjacent to the front of the seat. The industrial vehicles of the above two Publications are advantageous over the counterpart of the first-mentioned Publication in that the right foot of the operator will not be moved away from the accelerator pedal and an additional part such as an auxiliary pedal is not necessary. However, although the seat swiveling device permits changing of the facing direction of the operator's body from the forward-facing position slightly toward the right, it is difficult for the operator to push the accelerator pedal properly because the position of the accelerator pedal is fixed. Thus, operability of the accelerator pedal for use with the seat swiveling device needs to be improved.

An object of the present invention is to provide an accelerator pedal and an industrial vehicle having the same that require no complicated configuration, avoid increasing the number of parts and improve the pedal operability.

### SUMMARY OF THE INVENTION

In accordance with an aspect of the present invention, an industrial vehicle includes an operating pedal depressed by an operator for operating running of the industrial vehicle. The operating pedal includes a first pedal portion having a first step surface which is depressed by the operator while the operator maintains his or her posture to look forward and a second pedal portion having a second step surface which is depressed by the operator while the operator maintains his or her posture to look backward. The second pedal portion is formed on a lateral side of the first pedal portion so as to be inclines with respect to such that an angle made between the first step surface and the second step surface is an obtuse angle.

Other aspects and advantages of the invention will become apparent from the following description, taken in conjunction with the accompanying drawings, illustrating by way of example the principles of the invention.

### BRIEF DESCRIPTION OF THE DRAWINGS

The features of the present invention that are believed to be novel are set forth with particularity in the appended claims. The invention together with objects and advantages thereof, may best be understood by reference to the following description of the presently preferred embodiment together with the accompanying drawings in which:

FIG. 1 is an elevation view of a forklift truck according to a first preferred embodiment of the present invention;

FIG. 2 is a plan view showing the forklift truck of FIG. 1 with the top of operator's cabin removed for clarity of illustration;

FIG. 3A is a perspective view showing an accelerator pedal of the present invention;

FIG. 3B is a sectional view of the accelerator pedal taken along the line A-A of FIG. 3A;

FIG. 4 is an illustrative view showing a two different positions of the right foot of an operator relative to the accelerator pedal;

FIG. 5A is a schematic plan view showing a posture of the lower part of the body of the operator during driving the forklift truck in forward direction;

FIG. 5B is also a schematic plan view showing a posture of the lower part of the body of the operator during driving the forklift truck in backward direction while looking backward;

FIG. 6A is a perspective view showing an alteration example of an accelerator pedal of the present invention;

FIG. 6B is a side view of the accelerator pedal of FIG. 6A.

FIG. 6C is a sectional view of the accelerator pedal taken along the line B-B of FIG. 6A;

FIG. 7A is a perspective view showing another alteration example of accelerator pedal of the present invention;

FIG. 7B is a sectional view of the accelerator pedal taken along the line C-C of FIG. 7A; and

FIG. 8 is a schematic plan view showing an alteration example of providing a swivel shaft of a swivel seat.

### DETAILED DESCRIPTION OF THE PREFERRED EMBODIMENTS

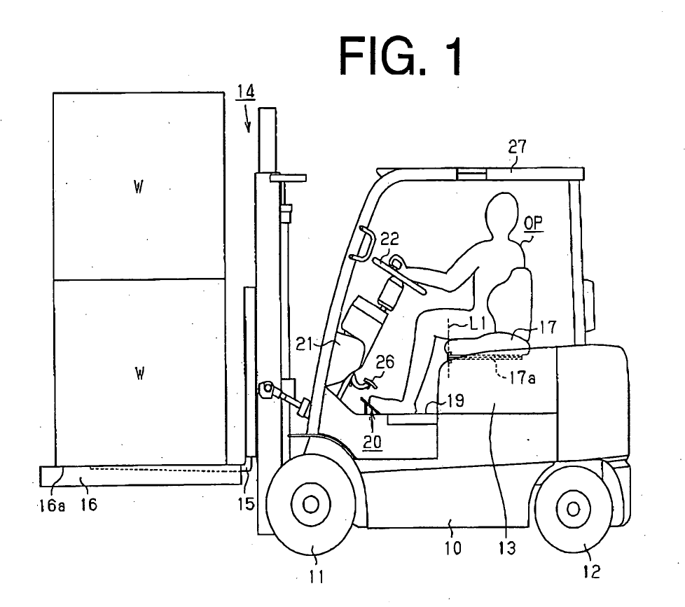

The following will describe a forklift truck as an industrial vehicle according to a preferred embodiment of the present invention with reference to FIGS. 1 through 5. In the following description, the references to directions or locations such as front, rear, left, right, up and down as viewed from the forklift truck operator OP seated on a swivel seat 17 and facing forward (or forward direction) are used.

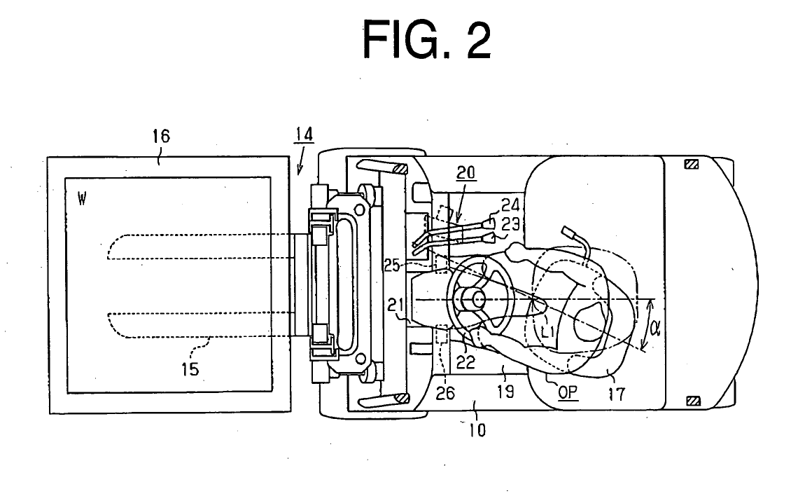

As shown in FIG. 1 and FIG. 2, the forklift truck has a pair of front wheels 11 and a pair of steerable rear wheels 12. An engine (not shown) is mounted in the center of a forklift truck body 10 and an engine hood 13 is mounted to cover the upper part of the engine. The front wheels 11 are driven by the engine for moving the forklift truck in forward or backward direction. The forklift truck further has a loading apparatus 14 which includes a working implement or a pair of forks 15 (only one fork being shown in the drawing) which is inserted into a pallet 16 in contact with its inner surface 16a and lifts a load W which is placed on the pallet 16. FIG. 1 shows a state in which two loads W are placed on the pallet 16, thereby blocking the forward view of the operator OP.

The swivel seat 17 as an operator's seat including a swiveling device 17a is provided on the top of the engine hood 13. As shown in FIG. 2, the swivel seat 17 is rotatable by the swiveling device 17a in clockwise direction as seen from the top for a predetermined swivel angle a from the position where the swivel seat 17 faces straight forward. The swivel angle a is about 20 degrees in this preferred embodiment. The pivot axis of the swivel seat 17 is located substantially at the center of the front end of the seat indicated by L1 in FIG. 2.

An accelerator pedal 20 as an operating pedal is disposed on a floor 19 of the forklift truck body 10 which is located under the feet of the operator OP seated on the swivel seat 17. An instrument panel 21 is provided in the front of the swivel seat 17 and a steering wheel 22 is mounted above the center of the instrument panel 21. A lift lever 23 and a tilt lever 24 are mounted on the right side of the steering wheel 22 for lifting and tilting operation. A brake pedal 25 and a clutch pedal 26 are disposed below and rearward of the Instrument panel 21. An overhead guard 27 is arranged above the swivel seat 17 so as to cover the operator OP.

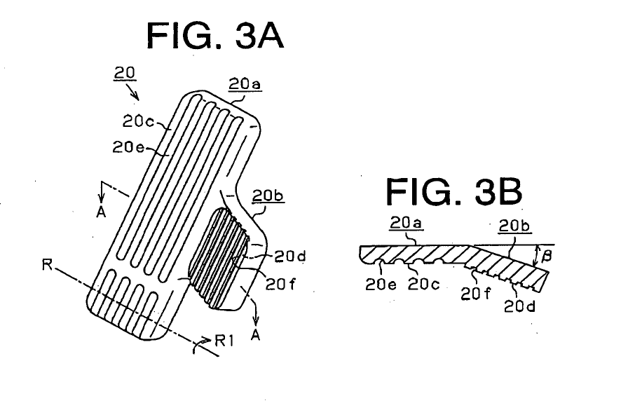

The following will describe the accelerator pedal 20 according to the preferred embodiment of the present invention with reference to FIGS. 3A and 3B. The accelerator pedal 20 includes a main pedal portion 20a as a first pedal portion and a sub-pedal portion 20b as a second pedal portion. The shape of the surface of the main pedal portion 20a is a parallelogram whose vertical lateral sides are longer than the horizontal top and bottom sides and the thickness of the main pedal portion 20a is a few centimeters. The main pedal portion 20a has a step surface 20c as a first step surface which faces the operator OP seated on the swivel seat 17 and is depressed by the operator OP in driving the forklift truck. Plural antislip grooves 20e are formed vertically in the step surface 20c of the main pedal portion 20a.

The shape of the surface of the sub-pedal portion 20b is a parallelogram and has substantially the same thickness as the main pedal portion 20a. The longitudinal length of the sub-pedal portion 20b as measured in vertical direction is about one-third of the main pedal portion 20a and width of the sub-pedal portion 20b is substantially the same as that of the main pedal portion 20a. The face of the sub-pedal portion 20b which faces the back of the forklift is a step surface 20d as a second step surface pushed by the operator OP in driving operation. The face of the sub-pedal portion 20b in this preferred embodiment faces the front of the operator OP when he or she is seated on the swivel seat 17. Plural antislip grooves 20f are formed in the step surface 20d of the sub-pedal portion 20b in the longitudinal direction thereof. The sub-pedal portion 20b is formed integral with the main pedal portion 20a on the right side thereof in parallel relation thereto. That is, the second pedal portion is located on the side to which the operator seat is rotated. As shown in FIG. 3B, the sub-pedal portion 20b extends rightward from the main pedal portion 20a at an inclination angle β that is made between the face of the sub-pedal portion 20b which faces the front of the forklift truck and an imaginary plane extending from the face of the main pedal portion 20a which faces the front of the forklift truck. In the present embodiment, this inclination angle β is about 20 degrees. Thus, the sub-pedal portion 20b is formed integrally with the main pedal portion 20a so as to be inclined with respect to such that the angle made between the step surface 20c of the main pedal portion 20a and the step surface 20d of the sub-pedal portion 20b is an obtuse angle. The obtuse angle and the inclination angle β make 180 degrees. It is preferable that the inclination angle β should be substantially same as the swivel angle a so that the step surface 20d of the sub-pedal portion 20b faces toward the operator OP when the swivel seat 17 on which the operator OP is seated is turned for the angle β.

Link mechanism which is connected to a throttle valve (not shown) is provided in the face of the main pedal portion 20a which faces the front of the forklift truck. Reference symbol R in FIG. 3A designates an axis which is located adjacent to and parallel to the bottom end of the main pedal portion 20a and about which the accelerator pedal 20 is pivoted when its main pedal portion 20a or sub-pedal portion 20b is depressed by the operator OP.

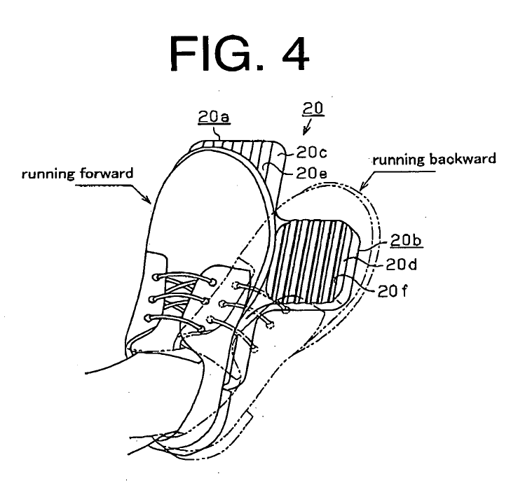

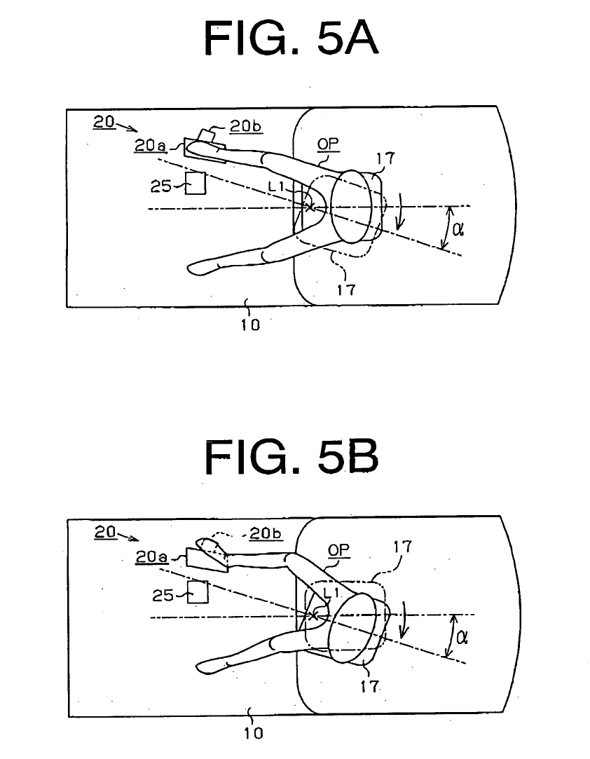

The following will describe traveling operation of the forklift truck which is constructed as described above with reference to FIGS. 4 and 5. In driving the forklift forward, the operator OP is seated on the swivel seat 17 in its straight forward position and, therefore, the operator OP is in forward facing position. In this state, the right foot of the operator OP is naturally positioned on the accelerator pedal 20 and the right knee is slightly opened to the right, as shown in FIG. 5A. Then, the entire right foot of the operator OP except the heel is placed on the step surface 20c of the main pedal portion 20a, as shown by the solid-line foot in FIG. 4. In this state, as the step surface 20c of the main pedal portion 20a is depressed by the right foot of the operator OP, the accelerator pedal 20 is turned in the direction R1 (FIG. 3A) around the pivot axis R. By so doing, the link mechanism which is connected to the throttle valve (not shown) opens the throttle valve depending on the extent to which the operator OP depressed the accelerator pedal 20. Accordingly, the engine speed is increased and the driving force is transmitted from the engine to the front wheels 11 in accordance with engine speed, thereby driving the forklift forward.

In driving the forklift truck backward, on the other hand, the operator OP takes a posture to look behind the forklift truck. For this purpose, the operator OP turns the swivel seat 17 clockwise as seen from the top for the angle a around the pivot axis L1, then the operator OP twists his or her upper part of the body to the right to look backward. In this state, the right knee of the operator OP is opened or moved rightward and the right foot of the operator OP is moved away from the main pedal portion 20a, as shown in FIG. 5B. As the operator OP twists his or her upper part of the body, the right foot is turned rightward about his or her heel, as shown by dotted-line foot in FIG. 4. Then, the toe of the right foot of the operator OP is placed on the step surface 20d of the sub-pedal portion 20b of the accelerator pedal 20. The operator OP twists his or her upper part of the body rightwardly backward and depresses the sub-pedal portion 20b while maintaining the posture to look backward. Depressing the sub-pedal portion 20b, the main pedal portion 20a, with which the sub-pedal portion 20b is made integral, is pivoted in the direction R1. In accordance with pivoting of the accelerator pedal 20, the throttle valve (not shown) is opened and the engine speed is increased. Then, the driving force of the engine is transmitted to the front wheels 11 and, therefore, the forklift truck is driven backward.

When the operator OP is looking backward, the heel of the right foot of the operator OP may be moved off from the floor 19 of the forklift truck with the movement of the knee of the same foot. In such a case, the accelerator pedal 20 of the present embodiment of the invention functions effectively to improve the operability of a forklift truck, as will be described below. When the position of the right heel of the operator OP is shifted by the twisting of the upper part of the body of the operator OP to look backward, the right heel of the operator OP is moved rightward by a distance corresponding to the width of one foot from the main pedal portion 20a to a position below the sub-pedal portion 20b. Thus, the heel of the operator OP is positioned below the sub-pedal portion 20b and the toe of the right foot of the operator OP is set on the step surface 20d of the sub-pedal portion 20b. The accelerator pedal 20 can be depressed by pushing the sub-pedal portion 20b with the right foot. The right heel may be positioned either at the main pedal portion 20a or a position below the sub-pedal portion 20b. The accelerator pedal 20 can be operated by the operator OP with his or her toe which is then placed on the sub-pedal portion 20b.

The following advantageous effects are obtained according to the above preferred embodiment.

(1) The accelerator pedal 20 having the main pedal portion 20a and the sub-pedal portion 20b which is provided specifically for the operator OP when driving the vehicle in backward direction improves the operability of the accelerator pedal 20 when driving forward or backward.

(2) Because the sub-pedal portion 20b is formed integrally with the main pedal portion 20a in the accelerator pedal 20, there is no need to provide additional parts such as an auxiliary accelerator pedal and the link mechanism thereof, which curbs an increase of the number of parts.

(3) Because of the integral construction of the main pedal portion 20a and the sub-pedal portion 20b in the accelerator pedal 20, assembling of additional parts for the accelerator pedal 20 is not required.

(4) Because of the integral construction of the main pedal portion 20a and the sub-pedal portion 20b in the accelerator pedal 20, the accelerator pedal 20 of the present invention is readily applicable to any existing forklift only by replacement of the accelerator pedal 20.

(5) The use of the swivel seat 17 together with the accelerator pedal 20 permits the operator OP to reduce the extent of twisting his or her body, thereby reducing the fatigue of the operator OP.

The present invention is not limited to the above-described embodiment but may be modified within the scope of the invention and it may be practiced in other various ways as exemplified below.

The accelerator pedal 20 is also applicable to an industrial vehicle in which its seat is fixed. In the vehicle having the combination of the fixed seat and the accelerator pedal 20, the operator OP twists the upper part of his or her body rightwardly backward to look behind and the right foot of the operator OP is placed at a position such that his or her toe is turned toward the right or moves away from the accelerator pedal 20. Thus, the operator OP can easily operate the accelerator pedal 20 by the depressing the sub-pedal portion 20b which is provided adjacent to the operator OP and, therefore, the pedal operability is improved.

The size of the sub-pedal portion 20b may be changed. If the seat is made with a larger swivel angle a, the position of the right foot of the operator OP moves further away from the accelerator pedal 20. Then, the size of the sub-pedal portion 20b may be changed such that it is extended laterally. In view of a case that the heel of the right foot of the operator OP who is looking backward is located below the sub-pedal portion 20b, the sub-pedal portion 20b may be made so as to have the same length as the main pedal portion 20a. In either case, operability of the accelerator pedal 20 can be improved.

The inclination angle β of the sub-pedal portion 20b may be between 0 degree and under 90 degrees. That is, the inclination angle β of the sub-pedal portion 20b with respect to the main pedal portion 20a may be changed so as to suit specific accelerator pedal used in each different model of industrial vehicle such as forklift truck. The inclination angle β may be selected from the above range according to the physique size and personal preference of the operator.

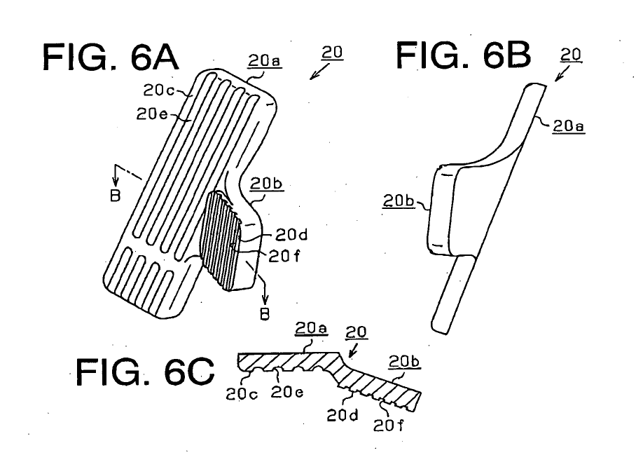

In the accelerator pedal 20, the sub-pedal portion 20b may be formed as shown in FIG. 6, wherein the sub-pedal portion 20b is tilted backward about its bottom side so that the plane of the step surface 20d extends substantially perpendicularly to the floor of the forklift truck. When the right foot of the operator OP is moved away from the accelerator pedal 20 in accordance with the twisting of the upper part of the body of the operator OP, the sub-pedal portion 20b is closer to the operator OP and, therefore, pedal operability can be improved.

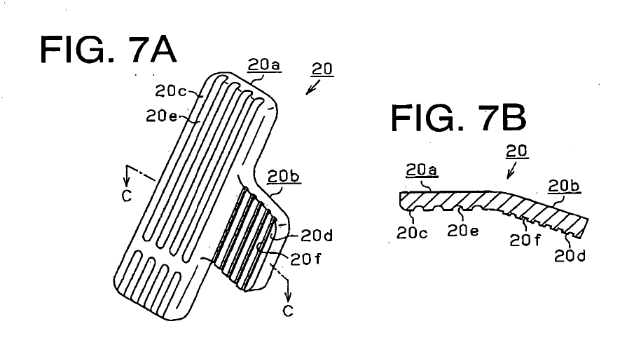

Part of the accelerator pedal 20 between the step surface 20c of the main pedal portion 20a and the step surface 20d of the sub-pedal portion 20b may be formed with a curvature, as shown in FIG. 7, which can be improve operability of the accelerator pedal 20 when the operator OP depresses the accelerator pedal 20 at the area thereof between the step surface 20d of the main pedal portion 20a and the step surface 20d of the sub-pedal portion 20b.

The accelerator pedal 20 may be constructed such that the sub-pedal portion 20b is detachably mounted to the main pedal portion 20a. An increase of the number of parts for such accelerator pedal is restricted as compared with the above-cited conventional art and good pedal operability is maintained. Additionally, the detachable sub-pedal portion 20b is advantageously applicable to an existing forklift truck without removing its existing accelerator pedal.

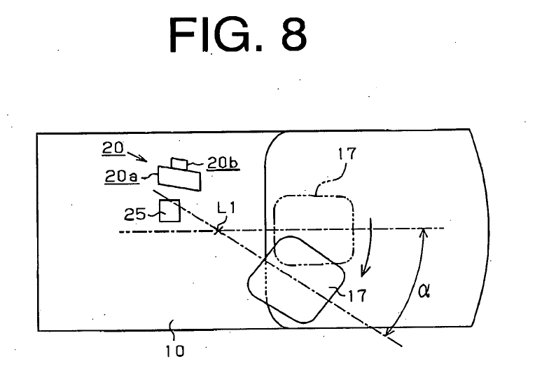

The pivot axis L1 of the swivel seat 17 may be located further forward of the center of the front end of the swivel seat 17 (refer to FIG. 8). By so arranging the swivel seat 17, the operator OP does not need to twist the upper part of the body so much as in the cases of the above-described embodiments in looking backward while driving the forklift truck.

The swivel seat 17 may be constructed so that it is rotatable in counter-clockwise direction as viewed from the top. In this case, the sub-pedal portion 20b is located on the left side of the main pedal portion 20a and the operator twists the upper part of the body toward the left in looking backward while driving the forklift truck. The operator OP can operate the sub-pedal portion 20b on the left side of the main pedal portion 20a when he or she looks backward and his or her foot is shifted leftward.

Although the above embodiments have been described with reference to the accelerator pedal 20, the present invention is applicable to the brake pedal 25 and the clutch pedal 26 as well for improvement of their pedal operability while the forklift is driven backward.

The present invention is further applicable to industrial vehicle other than the forklift truck, such as shovel loader, wheel loader and skid steer loader.

Therefore, the present examples and embodiment are to be considered as illustrative and not restrictive, and the invention is not to be limited to the details given herein but may be modified within the scope of the appended claims.

What is claimed is:

1. An industrial vehicle comprising:
an operating pedal depressed by an operator for operating running of the industrial vehicle,
wherein the operating pedal includes a first pedal portion having a first step surface which is depressed by the operator while the operator maintains his or her posture to look forward and a second pedal portion having a second step surface which is depressed by the operator while the operator maintains his or her posture to look backward, and
wherein the second pedal portion is formed on a lateral side of the first pedal portion so as to be inclines with respect to such that an angle made between the first step surface and the second step surface is an obtuse angle.

2. The industrial vehicle according to claim 1, wherein the second pedal portion is formed integral with the first pedal portion.

3. The industrial vehicle according to claim 2, wherein a part of the operating pedal between the first step surface and the second step surface is formed with a curvature.

4. The industrial vehicle according to claim 1, wherein the second pedal portion is further tilted backward.

5. The industrial vehicle according to claim 1, wherein the operating pedal is an accelerator pedal, a brake pedal or a clutch pedal.

6. The industrial vehicle according to claim 1, wherein an operator's seat is provided to be rotatable in at least one of clockwise and counter-clockwise directions as seen from the top for a predetermined angle from the position where the operator's seat faces straight forward about a pivot axis which is located forward of the center of the operator's seat, and the second pedal portion is located on the side to which the operator's seat is rotated.

7. An operating pedal for operating running of an industrial vehicle comprising:
a first pedal portion having a first step surface which is depressed by an operator while the operator maintains his or her posture to look forward;
a second pedal portion having a second step surface which is depressed by the operator while the operator maintains his or her posture to look backward,
wherein the second pedal portion is formed on a lateral side of the first pedal portion so as to be inclined with respect to such that an angle made between the first step surface and the second step surface is an obtuse angle.

8. The operating pedal according to claim 7, wherein the second pedal portion is formed integral with the first pedal portion.

9. The operating pedal according to claim 7, wherein a part of the operating pedal between the first step surface and the second step surface is formed with a curvature.

10. The operating pedal according to claim 7, wherein the second pedal portion is further tilted backward.

11. The operating pedal according to claim 7, wherein the operating pedal is an accelerator pedal, a brake pedal or a clutch pedal.
